(19) United States
(12) Patent Application Publication
(10) Pub. No.: US 2015/0039716 A1
(43) Pub. Date: Feb. 5, 2015

(54) Management of a Networked Storage System Through a Storage Area Network

(71) Applicant: Coraid, Inc., Redwood City, CA (US)

(72) Inventors: Robert J. Przykucki, JR., Redwood City, CA (US); Samuel A. Hopkins, Foster City, CA (US)

(73) Assignee: Coraid, Inc., Redwood City, CA (US)

(21) Appl. No.: 13/957,272

(22) Filed: Aug. 1, 2013

(51) Int. Cl. H04L 29/08

(52) U.S. Cl. CPC H04L 67/1097
USPC 709/214

(57) ABSTRACT

Management of a networked storage system through a storage area network (SAN). The storage system includes a storage host, a server, and a management host. The storage host includes a plurality of storage devices. The server is configured to access the storage devices of the storage host via the SAN. The server is also configured to transmit attribute information via the SAN, where the attribute information describes at least one attribute of the server. The management host is configured to receive the attribute information and to determine a desired configuration change to the storage system based on the attribute information. The desired configuration change affects access by the server to the storage devices of the storage host via the SAN.

### BACKGROUND

1. Field of the Disclosure

This disclosure pertains in general to storage management, and in particular to management of networked storage system through a storage area network.

2. Description of the Related Art

A networked storage system includes servers and storage hosts. Data is stored in the storage hosts and servers access the data in the storage hosts through a storage area network (SAN). A large number of storage hosts and servers can communicate through a single SAN. Additionally, storage hosts and servers are constantly being removed and added to the storage system. As a result, managing the resources of the storage system can be a challenge.

The storage hosts and servers are typically connected to a management network separate from the SAN that is used for management of the storage system. Management information is communicated to and from the servers through the management network. However, the use of two separate networks—one for data access and one for management, adds complexity to the management of the storage system. For example, it requires a server administrator to manually install a management agent on the server and for a network administrator to open up TCP/UDP ports for the management agent so that management information can be communicated across the management network.

Additionally, the I/O performance of the storage system is typically monitored and controlled in the storage hosts. However, measuring monitoring and controlling performance at the storage host only provides limited control over performance within the SAN. This leads to situations where the servers can compete for bandwidth and negatively impact the performance of the other servers, despite the best efforts of the storage hosts to prevent this from happening. For example, even if each storage host limits the bandwidth that it provides to a given server, the server may still consume a large portion of the SAN bandwidth by accessing multiple storage hosts at the same time, thereby increasing the access latency by other servers.

### SUMMARY

Embodiments of the present disclosure are related to management of a networked storage system through a storage area network (SAN), which reduces the complexity of managing the storage system and increases control over the performance of the storage system. In one embodiment, a storage system includes a storage host coupled to the SAN, and the storage host includes a plurality of storage devices. A server is coupled to the SAN. The server is configured to access the storage devices of the storage host via the SAN. The server is also configured to transmit attribute information via the SAN, where the attribute information describes at least one attribute of the server. A management host is configured to receive the attribute information and to determine a desired configuration change to the storage system based on the attribute information. The desired configuration change affects access by the server to the storage devices of the storage host via the SAN.

In one embodiment, the attribute information describes an I/O performance attribute of the server that is measured at the server. The management host may analyze the I/O performance attributes and determine that the I/O performance of the server should be throttled at the server. In one embodiment, the attribute information can describe a static attribute of the server.

In one embodiment, a computer implemented method of operation in a server that communicates with a storage host through a SAN is disclosed. Storage devices of the storage host are accessed via the SAN. Attribute information is transferred to a management host via the SAN, the attribute information describing at least one attribute of the server. A management command is received via the SAN from the management host responsive to transmitting the attribute information, the management command for implementing a desired configuration change to the server that affects access by the server to the storage devices of the storage host via the SAN.

In one embodiment, a computer implemented method of managing a storage system through a SAN is disclosed. Attribute information is received describing at least one attribute of the server, the attribute information being transmitted by the server via the SAN. A desired configuration change to the storage system is determined based on the attribute information, the desired configuration change affecting access by the server to the storage devices of the storage host via the SAN. A management command is transmitted for implementing the desired configuration change in the storage system.

### BRIEF DESCRIPTION OF THE DRAWINGS

The teachings of the embodiments disclosed herein can be readily understood by considering the following detailed description in conjunction with the accompanying drawings.

FIG. 1 is a high-level block diagram of a storage system that includes a storage area network, according to one embodiment.

FIG. 2 is a detailed view of the management module of FIG. 1, according to one embodiment.

FIG. 3A is a flowchart illustrating a process of storage management performed by the management module of the management host, according to one embodiment.

FIG. 3B is a flowchart illustrating a process of storage management performed by the modules of a server, according to one embodiment

FIG. 4 is an interaction diagram illustrating one example of storage management communications between components of the storage system, according to one embodiment.

FIG. 5 is a high-level block diagram of a storage system that includes a storage area network, according to another embodiment.

FIG. 6 illustrates the hardware architecture of a computer, according to one embodiment.

### DETAILED DESCRIPTION

The Figures (FIG.) and the following description relate to various embodiments by way of illustration only. It should be noted that from the following discussion, alternative embodiments of the structures and methods disclosed herein will be readily recognized as viable alternatives that may be employed without departing from the principles discussed herein.

Reference will now be made in detail to several embodiments, examples of which are illustrated in the accompanying figures. It is noted that wherever practicable similar or like reference numbers may be used in the figures and may indicate similar or like functionality. The figures depict various embodiments for purposes of illustration only. One skilled in the art will readily recognize from the following description that alternative embodiments of the structures and methods illustrated herein may be employed without departing from the principles described herein.

Embodiments disclosed herein describe management of a networked storage system through a SAN. The storage system includes a storage host, a server, and a management host. Management information is transmitted to and from the server through the SAN, which simplifies the management of the storage system. Additionally, I/O performance of the storage system can be measured and controlled at the servers, which increases control over the performance of the storage system.

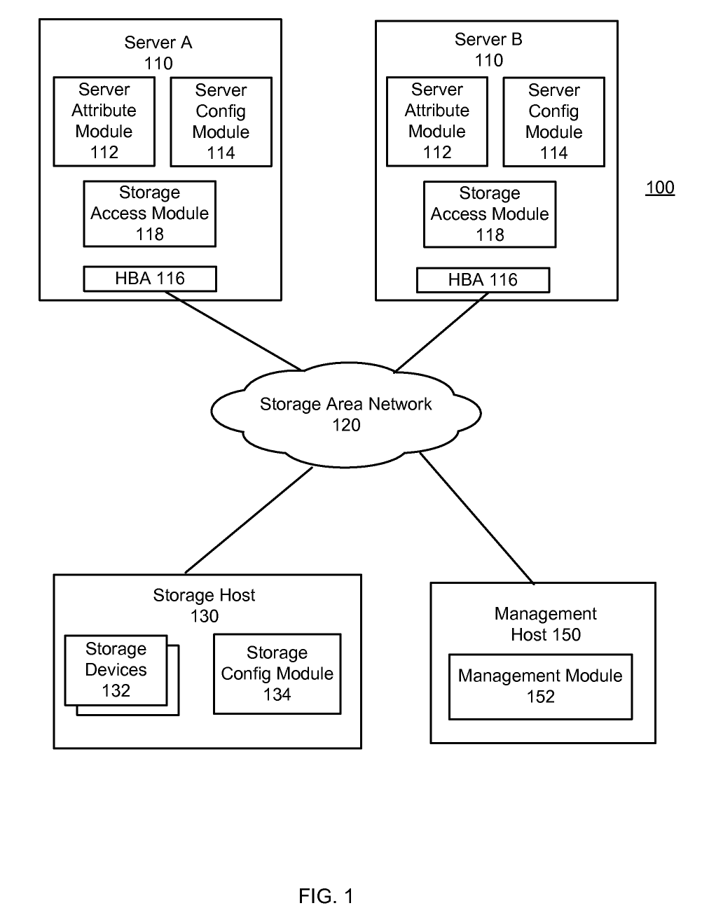

FIG. 1 is a high-level block diagram of a storage system 100 that includes a storage area network (SAN) 120, according to one embodiment. The storage system 100 includes several servers 110, a storage host 130 and a management host 150 all connected to SAN 120. Only two servers 110 and a single storage host 110 are shown in FIG. 1 to simplify and clarify the description. In other embodiments the computing environment 100 can have a larger number of servers 110 and/or storage hosts 130.

SAN 120 is a dedicated network that provides access to consolidated, block level data storage in the storage host 130. The SAN 120 may include communication links using technologies such as Ethernet or Fibre Channels. Servers 110 and storage host 130 an communicate over the SAN using a communication protocol such as ATA over Ethernet (AoE), Fiber Channel Protocol (FCP), Fiber Channel over Ethernet (FCoE), or other appropriate communication protocol. The SAN 120 can be located in one physical location or can span multiple physical locations. The SAN 120 may include one or more network switches (not shown) that route communications in the SAN 120 between servers 110 and the storage host 130.

Servers 110, storage host 130, and management host 150 are all computing devices, such as server class computers with processors and memory. The servers 110 initiate data transfer with the storage host 130 across the SAN 120. The storage host 130 provides storage services to the servers 110 through the SAN 120. Storage host 130 includes several storage devices 132, such as magnetic disk drives, solid state drives, etc. Storage host 130 forms the storage devices 132 into storage repositories, which can be a single storage device 132, a collection of storage devices 132, or part of a storage device 132. Each repository is given a logical unit number (LUN) and assigned to one or more of the servers 110. The servers 110 access the LUNs through the SAN 120 and the LUNs appear as locally attached storage to the servers 110.

The storage host 130 also includes a storage configuration module 134. The storage configuration module 134 receives management commands from the management host 150 describing desired configuration changes to the storage host 130. The storage configuration module 134 implements the desired configuration changes described by the management commands. An example of a management command for the storage host 130 may be a command to create a LUN and to assign the LUN to Server A 110 by masking the LUN using the physical address of a Host Bus Adapter (HBA) port of Server A 110. Masking exposes a LUN to a physical address so that only that physical address can access the LUN.

Each server 110 includes a server attribute module 112, a server configuration module 114, a HBA 116, and a storage access module 118. The HBA 116 is a piece of hardware that connects the server 110 to the SAN 120 through one or more physical ports of the HBA 116. Each port of the HBA 116 has a unique physical address, such as a media access control (MAC) address, that identifies the HBA port. Examples of HBAs 116 are Ethernet adapters, Fibre Channel adapters, etc. In some embodiments each server 110 may have more than one HBA 116 connecting the server 110 to the SAN 120.

The storage access module 118 accesses the storage devices 132, or more specifically, the LUNs that are assigned to a server 110. The storage access module 118 accesses the storage devices 132 through the HBA 116 and the SAN 120. During the storage access, the storage access module 118 can transfer data with the storage devices 132 by either writing data to or reading data from the storage devices 132. Additionally, storage access module 118 uses a network communication protocol that is specifically designed for storage access across the SAN 120. For example, the storage access module 118 can use the AoE protocol to transfer data across the SAN the SAN 120.

The server attribute module 112 collects and transmits attribute information describing attributes of the server 110 to the management host 150 across the SAN 120. The attribute information can describe two types of attributes: (1) static attributes or (2) input output (I/O) performance attributes. A static attribute describe a configuration of the server that is generally fixed and does not change frequently or at all, and may sometimes be referred to as server metadata. An example of a static attribute is a physical address of a HBA 116 port. I/O performance attributes describe the I/O performance of the server 110 when the server 110 is accessing the storage devices 132, and are measured as the server 110 is accessing a LUN of the storage host 130 through the SAN 120. An example of an I/O performance attribute is an I/O throughput per LUN.

The server configuration module 114 receives management commands from the management host 150 describing desired configuration changes to the server 110. The server configuration module 114 implements the desired configuration changes described by the management commands. An example of a management command for the server 110 may be a command to throttle I/O performance of the server 110, thereby limiting the I/O performance of the server 110 when accessing the storage devices 132 via the SAN 120. The I/O performance of the server 110 can be throttled in a number of different ways, such as by restricting the number of outstanding I/O requests or capping the maximum I/O throughput.

As used herein, management information refers collectively to both the attribute information and management commands. In one embodiment, the server 110 transmits and receives management information through the SAN 120 using a network communications protocol that is capable of carrying management information. Thus, one network communication protocol is used for accessing storage across the SAN 120 while a different network communication protocol is used for transferring management information across the SAN 120. As an example, the protocol used to carry management information can be a distributed management protocol which enables all devices connected to the SAN 120 to describe information about themselves in an organized manner. Each device displays itself as a file directory in a distributed file system. Once displayed, the device file system can be walked through to discover state and other capabilities and attributes of the device.

The management host 150 includes a management module 152. The management module 152 receives attribute information from the servers 110 and uses the attribute information to determine desired configuration changes to the storage system 100. The desired configuration changes affect access by the servers 110 to the storage devices of the storage host 130. For example, the desired configuration changes can affect which LUNs are assigned to the servers 110, the hardware configuration of the LUNs, or the performance of the servers 110 in transferring data with the LUNs. The management module 152 then transmits management commands to the servers 110 or storage host 130 that cause the servers 110 or storage host 130 to implement the desired configuration changes.

Beneficially, the servers 110 can both access storage and transfer management information across the SAN 120. Because the management information is transferred in and out of the servers 110 across the SAN 120, a separate communications port does not need to be opened for transferring management information, thereby simplifying the management of the storage system 100. In other words, the system 100 uses the data plane to transmit both data and management information.

Additionally, in one embodiment, the server attribute module 112 and server configuration module 114 are components of an HBA driver. The server attribute module 112 measures the I/O performance attributes as data passes between an operating system (OS) and the HBA driver or between the HBA driver and the HBA ports. The server configuration module 114 implements I/O throttling in the HBA driver. Because I/O performance is measured directly at the servers 110 and I/O throttling is performed inside the servers 110, this increases management control over the performance of the storage system 100 when compared to systems that only measure and control performance inside of the storage host 130.

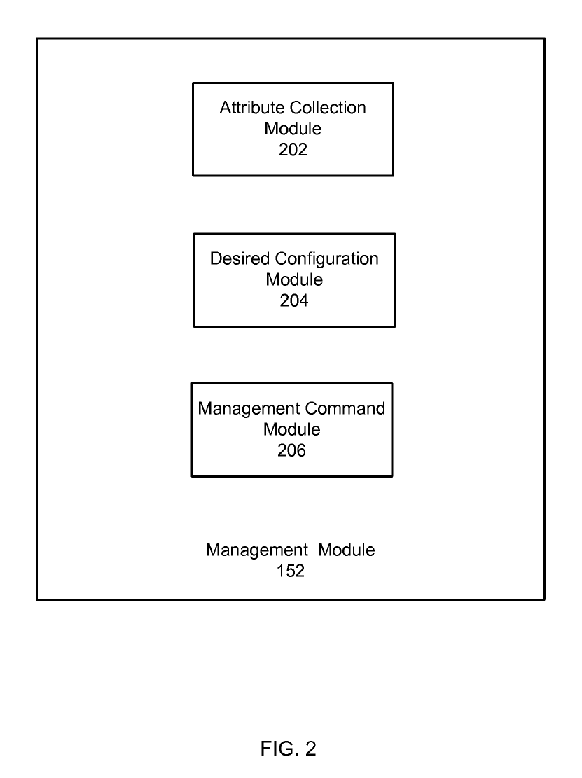

FIG. 2 is a detailed view of the management module 152 of FIG. 1, according to one embodiment. The management module 152 includes an attribute collection module 202, a desired configuration module 204, and a management command module 206. In other embodiments there may be a different number of modules and the functionality described as being in one module may be distributed amongst the other modules.

The attribute collection module 202 receives attribute information that was generated by the servers 110 and transmitted across the SAN 120. The attribute collection module 202 may periodically poll the servers 110 through the SAN 120 for the attribute information. Alternatively, the servers 110 may automatically provide the attribute information to the attribute collection module 202 through the SAN 120 on a periodic basis.

As previously mentioned, the attribute information can describe static attributes or I/O performance attributes. Examples of static attributes include but are not limited to the following attributes:
HBA physical address
HBA firmware revision
HBA negotiated link speed (e.g., 100 Mbps, 1 Gbps)
LUNs currently masked to the server 116
Server OS
Server name (e.g., server name from OS)

Examples of I/O performance attributes include but are not limited to the following attributes:
OS I/O operations per second (IOPS) per LUN
OS I/O throughout per LUN
OS I/O histogram size per LUN (e.g., representing distribution of read/write block sizes)
OS I/O read or write counter per LUN
OS I/O Sequential or Random counter per read/write I/O per LUN
OS SCSI timeouts per LUN
OS Outstanding I/O Thread counter per read/write per LUN
AoE IOPS per LUN per HBA port
AoE read or write IOPS per LUN per HBA port
AoE I/O latency per LUN per HBA port
AoE I/O retransmits (e.g., due to lost packets) per LUN per HBA port
AoE I/O read or write throughput per LUN per HBA port
AoE link state up or down counter per HBA port (e.g., counters that are incremented whenever an HBA port is disconnected or reconnected from the SAN 120)

The desired configuration module 204 determines a desired configuration change to the storage system 100 using the attribute information. The desired configuration change affects access by a server 110 to the storage devices 132 of the storage host 130. The desired configuration change can be a change to the configuration of the server 110. Examples of configuration changes to the server 100 can be throttling of I/O performance or claiming a LUN that has been assigned to the server 100. The desired configuration change can also be a change to the configuration of the storage host 130. Examples of configuration changes to the storage host 130 can be masking of a LUN to a physical address, or creation of a new LUN.

In one embodiment, the desired configuration module 204 can determine the desired configuration changes by presenting the attribute information to an administrator for analysis. The attribute information can be presented in a user interface or through other appropriate techniques for attribute visualization. The desired configuration module 204 then receives an input from the administrator providing the desired configuration changes. In other embodiments, the desired configuration changes can be automatically determined from the attribute information, for example, by applying a set of pre-determined rules to the attribute information. The desired configuration changes can be presented to an administrator as a recommendation for the administrator's approval.

Several examples are now provided for desired configuration changes determined from the attribute information. As indicated in the following examples, the desired configuration changes can be changes to the configuration of the servers 110 or the storage host 130, depending on the specific attribute information that is received.

### Example 1

The management host 150 receives static attributes describing a physical address of an HBA 116 from server A 110, the name of the server A 110, and the OS of server A110. The desired configuration module 204 presents these attributes to the administrator to inform the administrator that a new server 110 has been discovered. The administrator views the attributes and decides that a new LUN should be assigned to the server 110. The desired configuration module 204 receives an input from the administrator specifying that a LUN should be created and that the LUN should be masked to the physical address of HBA 116.

### Example 2

Server A 110 and server B 110 are communicating with different LUNs of the storage host 130. The management host 150 receives an AoE I/O latency attribute for server B 110 indicating that latency is spiking at server B 110. The management host 150 also receives an AoE I/O throughput attribute for server A 110. The attributes are presented to an administrator, who decides that server 110 should be throttled because it is consuming too much bandwidth and causing latency problems at server B 110. The administrator requests the I/O performance of server A 110 to be throttled, and this throttling request is received by the desired configuration module 204. By throttling the I/O performance of server A 110, the latency for server B 110 should return to normal.

### Example 3

The management host 150 receives an OS I/O sequential counter per read/write I/O per LUN attribute indicating that most of the accesses to a LUN from server A are sequential I/O reads. The LUN is currently provisioned from storage devices 132 in a RAID-10 configuration, which is good for random I/O but not for sequential I/O. This attribute is presented to an administrator, who decides that the LUN should be re-configured as a RAIDS instead of RAID10 for better sequential I/O performance. The administrator then requests the creation of a RAID 5 LUN, and this request is received by the desired configuration module 204.

The management command module 206 generates management commands for implementing the desired configuration changes, and that describe the desired configuration changes. The management commands are transmitted to the servers 110 if the changes are to be implemented by the servers 110. The management commands are transmitted to the storage host 130 if the changes are to be implemented by the storage host 130. The management commands reach the servers 110 or the storage hosts 130 through the SAN 120 and cause the servers 110 or the storage hosts 130 to implement the desired configuration changes.

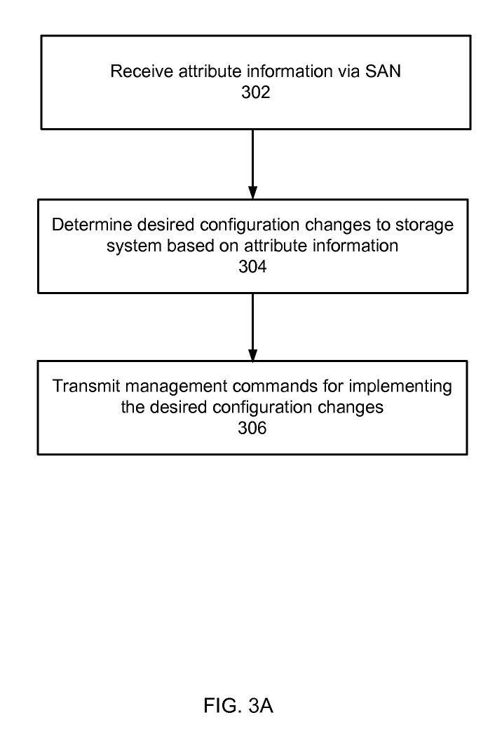

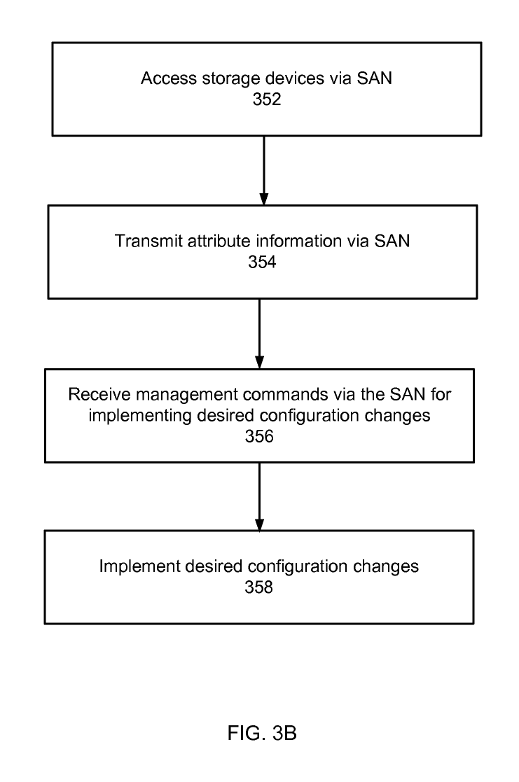

FIG. 3A is a flowchart illustrating a process of storage management performed by the management module 152 of the management host 150, according to one embodiment. In step 302, the management module 152 receives attribute information from at least one of the servers 110 that has been transmitted through the SAN 120. The attribute information describes at least one attribute of the server 110 that transmitted the attribute information. In step 304, the management module 152 determines a desired configuration change to the storage system 100 based on the attribute information. The desired configuration change affect access by one or more of the servers 110 to the storage devices 132 of the storage host 130. In step 306, the management module 152 transmits a management command for implementing the desired configuration changes. The management command can be transmitted across the SAN 120 to the servers 110 or storage host 130.

FIG. 3B is a flowchart illustrating a process of storage management performed by the modules of a server 110, according to one embodiment. In step 352, the server 110 accesses the storage devices 132 of the storage host 130 via the SAN 120. In step 354, the server 110 transmits attribute information to the management host 150 via the SAN 120. The attribute information describes at least one attribute of the server 110. In step 356, the server 110 receives a management command via the SAN 120 from the management host 150. The management command is for implementing a desired configuration change to the server 110 that affects access by the server 110 to the storage devices 132 of the storage host 130 via the SAN 120. For example, the desired configuration change can involve throttling the I/O performance of the server 110. In step 358, the server 110 implements the desired configuration change at the server 110.

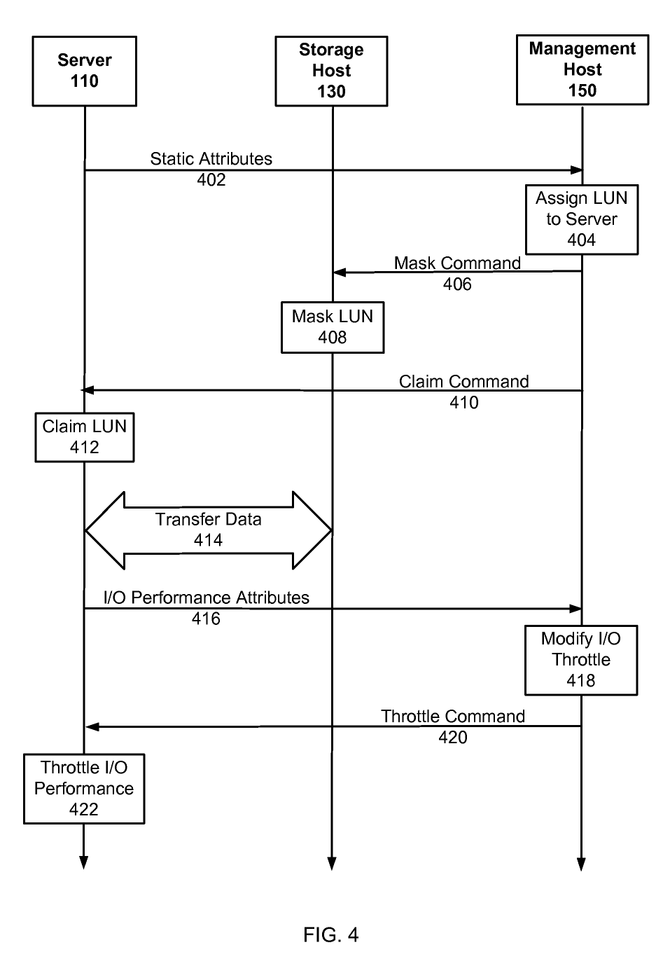

FIG. 4 is an interaction diagram illustrating storage management communications between components of the storage system 100, according to one embodiment. Initially, the server 110 transmits static attributes 402 to the management host 150. The static attributes 402 include a physical address of an HBA 116. The management host 150 then determines that it should assign 404 a LUN to the server 110 based on a request from an administrator. The management host 150 transmits a mask command 406 that causes the storage host 130 to create a new LUN and mask 408 the new LUN to the physical address of the HBA 116. The management host 150 also generates a claim command 410 that causes the server 110 to claim 412 the new LUN. During the masking and claiming processes, the storage administrator does not need to manually discover the HBA port physical address as it is already known to the management host 150.

The server 110 accesses the storage devices 132 of the storage host 130 and transfers data with the storage host 130. As the data is being transferred 414, the server 110 measures I/O performance attributes 416 of the server 110. The server 110 transmits the I/O performance attributes 416 to the management host 150. The management host 150 processes the I/O performance attributes 416 and determines that the I/O performance of the server 110 should be throttled. The management host 150 then transmits a throttle command 420 to the server 110, thereby causing the server 110 to throttle 422 its I/O performance.

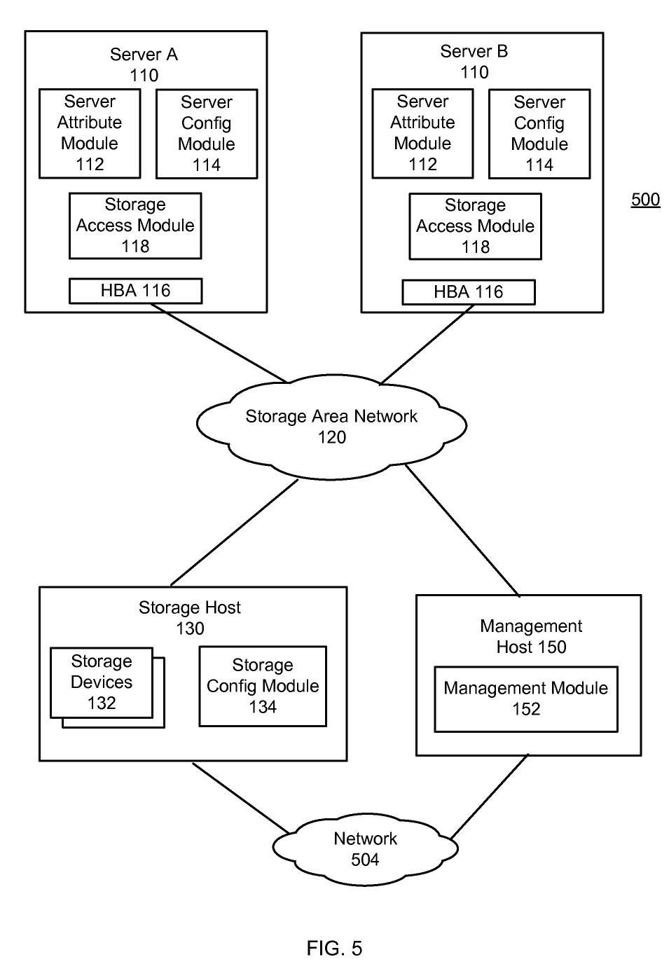

FIG. 5 is a high-level block diagram of a storage system 500 that includes a SAN 120, according to another embodiment. The storage system 500 of FIG. 5 is similar to the storage system 100 of FIG. 1, except that now the management host 150 is not directly connected to the SAN 120. Instead, the management host 150 is indirectly connected to the SAN 120 through network 504 and storage host 130.

Network 504 represents the communication pathways between the storage host 130 and the management host 150. The network 504 can be an internal network or the Internet. In one embodiment, the network 504 uses standard communications technologies and/or protocols. Thus, the network 504 can include links using technologies such as Ethernet, 802.11, integrated services digital network (ISDN), digital subscriber line (DSL), asynchronous transfer mode (ATM), etc. Similarly, the networking protocols used on the network can include the transmission control protocol/Internet protocol (TCP/IP), the hypertext transport protocol (HTTP), the simple mail transfer protocol (SMTP), the file transfer protocol (FTP), etc. The data exchanged over the network 504 can be represented using technologies and/or formats including the hypertext markup language (HTML), the extensible markup language (XML), etc. In addition, all or some of the links can be encrypted using conventional encryption technologies such as the secure sockets layer (SSL), Secure HTTP and/or virtual private networks (VPNs).

In storage system 500, management information is communicated between the management host 150 and the servers 110 through the SAN 120, the storage host 130, and the network 504. For example, attribute information is transmitted by the server 110 across the SAN 120, re-transmitted by the storage host 130 across the network 504, and then received by the management host 150. Similarly, management commands are transmitted by the management host 150 across the network 504 and re-transmitted by the storage host 130 across the SAN 120. The management commands then reach the server 110 through the SAN 120 and are received by the server 110. Thus, similar to storage system 100 of FIG. 1, the storage system 500 of FIG. 5 also uses the SAN 120 for transmission of management information to and from the servers 110.

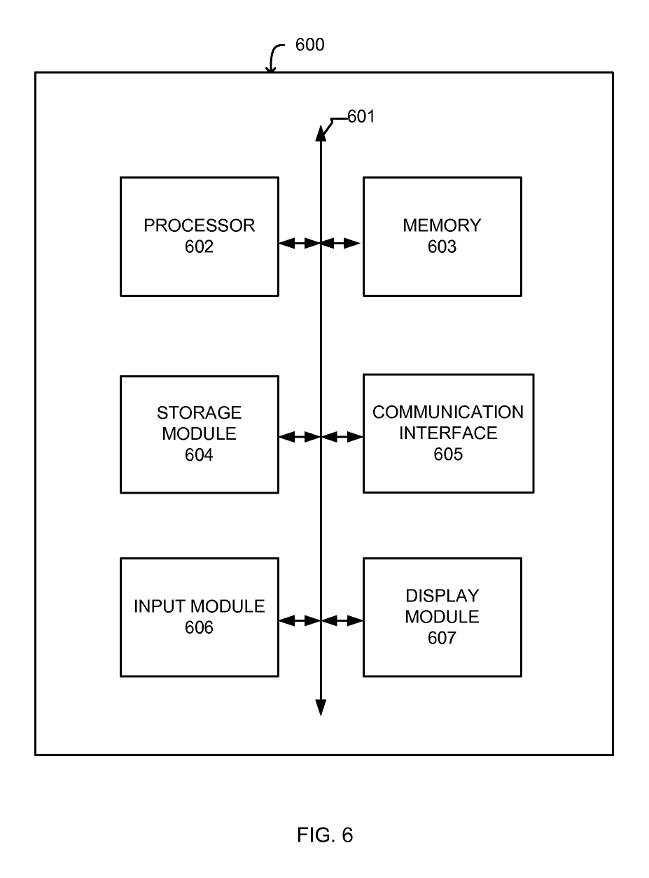

FIG. 6 illustrates the hardware architecture of a computer 600, according to one embodiment. The computer 600 may represent the server 110, the storage host 130, or the management host 150. The computer 600 includes components such as a processor 602, a memory 603, a storage module 604, an input module (e.g., keyboard, mouse, and the like) 606, a display module 607 and a communication interface 605, exchanging data and control signals with one another through a bus 601. The storage module 604 is implemented as one or more non-transitory computer readable storage media (e.g., hard disk drive, solid state memory, etc), and stores software instructions that are executed by the processor 502 in conjunction with the memory 503 to implement the storage management described herein. For example, the storage module 604 may include instructions in the form of any of the modules described in FIG. 1 or FIG. 2. Operating system software and other application software may also be stored in the storage module 604 to run on the processor 602.

As can be seen from the description above, the embodiments herein perform management of a networked storage system 100 through the SAN 120. Management information is transmitted to and from the servers 110 through the SAN 120, which simplifies the management of the storage system 100. Additionally, I/O performance of the storage system 100 can be measured and controlled at the servers 110, which increases control over the performance of the storage system 100.

Upon reading this disclosure, those of skill in the art will appreciate still additional alternative designs for management of a storage system through a storage area network. Thus, while particular embodiments and applications of the present disclosure have been illustrated and described, it is to be understood that the embodiments are not limited to the precise construction and components disclosed herein and that various modifications, changes and variations which will be apparent to those skilled in the art may be made in the arrangement, operation and details of the method and apparatus of the present disclosure disclosed herein without departing from the spirit and scope of the disclosure as defined in the appended claims.

What is claimed is:

1. A storage system, comprising:
a storage host coupled to a storage area network (SAN), the storage host including a plurality of storage devices;
a server coupled to the SAN, the server configured to access the storage devices of the storage host via the SAN and to transmit attribute information via the SAN, the attribute information describing at least one attribute of the server; and
a management host configured to receive the attribute information and to determine a desired configuration change to the storage system based on the attribute information, the desired configuration change affecting access by the server to the storage devices of the storage host via the SAN.

2. The storage system of claim 1, wherein the desired configuration change is a desired configuration change to the server, and wherein the management host transmits a management command for implementing the desired configuration change that reaches the server via the SAN.

3. The storage system of claim 1, wherein the desired configuration change is a desired configuration change to the storage host, and wherein the management host transmits a management command for implementing the desired configuration change that reaches the storage host via the SAN.

4. The storage system of claim 1, wherein the attribute information describes at least one static attribute of the server.

5. The storage system of claim 4, wherein the static attribute is a physical address of the server and the desired configuration change to the storage system is masking of a LUN to the physical address of the server.

6. The storage system of claim 1, wherein the attribute information describes at least one I/O performance attribute of the server measured at the server.

7. The storage system of claim 1, wherein the desired configuration change is throttling of I/O performance of the server.

8. The storage system of claim 1, wherein the storage devices are accessed via the SAN using a first communication protocol and the attribute information is transmitted via the SAN using a second communication protocol that is different than the first communication protocol.

9. A computer implemented method of operation in a server that communicates with a storage host through a storage area network (SAN), the method comprising:
accessing storage devices of the storage host via the SAN; and
transmitting attribute information to a management host via the SAN, the attribute information describing at least one attribute of the server; and
receiving a management command via the SAN from the management host responsive to transmitting the attribute information, the management command for implementing a desired configuration change to the server that affects access by the server to the storage devices of the storage host via the SAN.

10. The method of claim 9, wherein the attribute information describes at least one static attribute of the server.

11. The method of claim 9, wherein the attribute information describes at least one I/O performance attribute of the server measured at the server.

12. The method of claim 9, wherein the desired configuration change is throttling of I/O performance of the server.

13. The method of claim 9, wherein the storage devices of the storage host are accessed via the SAN using a first communication protocol and the attribute information is transmitted via the SAN using a second communication protocol that is different than the first communication protocol.

14. A computer implemented method of managing a storage system, the storage system including a server that communicates with a storage host through a storage area network (SAN), the method comprising:
receiving attribute information describing at least one attribute of the server, the attribute information transmitted by the server via the SAN;
determining a desired configuration change to the storage system based on the attribute information, the desired configuration change affecting access by the server to the storage devices of the storage host via the SAN; and
transmitting a management command for implementing the desired configuration change in the storage system.

15. The method of claim 14, wherein the desired configuration change is a desired configuration change to the server, and the management command reaches the server via the SAN.

16. The method of claim 14, wherein the desired configuration change is a desired configuration change to the storage host, and wherein the management command reaches the storage host via the SAN.

17. The method of claim 14, wherein the attribute information describes at least one static attribute of the server.

18. The method of claim 17, wherein the static attribute is a physical address of the server and the desired configuration change to the storage system is masking of a LUN to the physical address of the server.

19. The method of claim 14, wherein the attribute information describes at least one I/O performance attribute of the server measured at the server.

20. The method of claim 14, wherein the desired configuration change is throttling of I/O performance of the server.

21. The method of claim 14, wherein the server accesses the storage devices of the storage host via the SAN with a first communication protocol and the attribute information is transmitted by the server via the SAN using a second communication protocol that is different than the first communication protocol.
